(19) United States
(12) Patent Application Publication
(10) Pub. No.: US 2012/0073846 A1
(43) Pub. Date: Mar. 29, 2012

(54) POWER TOOL

(75) Inventors: Shouichi HIRAI, Ibaraki (JP); Kazutaka IWATA, Ibaraki (JP)

(73) Assignee: HITACHI KOKI CO., LTD.,, Tokyo (JP)

(21) Appl. No.: 13/235,323

(22) Filed: Sep. 16, 2011

(30) Foreign Application Priority Data
Sep. 29, 2010 (JP) 2010-219851

(51) Int. Cl. B25B 21/02; B25D 11/06

(52) U.S. Cl. 173/200

(57) ABSTRACT

An oil pulse tool including: a brushless motor which includes stator windings; a drive circuit configured to apply a driving voltage to any of the stator windings of the brushless motor at a predetermined timing; an oil pulse mechanism portion configured to be rotary driven by the brushless motor; and an output shaft which is connected to the oil pulse mechanism portion, wherein the drive circuit changes an advance angle of the driving voltage in accordance with a rotational position of the oil pulse mechanism portion.

### CROSS-REFERENCE TO RELATED APPLICATIONS

This application claims priority from Japanese Patent Application No. 2010-219851 filed on Sep. 29, 2010, the entire contents of which are incorporated herein by reference.

### TECHNICAL FIELD

Aspects of the present invention relate to a power tool driven by a motor and having a front end tool, and in particular, to a power tool which receives a reaction force, which fluctuates, when the front end tool works. An oil pulse tool is an example of such a power tool.

### BACKGROUND

As a power tool for screwing a screw or a bolt, there is known an oil pulse tool which generates a striking force by using hydraulic pressure. The oil pulse tool is advantageous over a mechanical impact tool in that operating noise is low because there is no collision between metal parts. As an oil pulse tool like this, JP-A-2003-291074 discloses an oil pulse tool which employs an electric motor for supplying power to drive an oil pulse mechanism portion. When an on/off trigger is pulled to actuate the oil pulse tool, a predetermined driving electric power is supplied to the motor. When the motor rotates, the rotation of the motor is slowed via a speed reduction gear mechanism portion so as to be transmitted to the oil pulse mechanism portion, whereby an anvil (an output shaft) is rotated via the oil pulse mechanism portion.

In the technique disclosed in JP-A-2003-291074, the oil pulse mechanism portion includes an anvil having a substantially rod shape and directed towards a front of an outer case, a cylindrical member (a liner) provided substantially concentrically with the anvil and radially outwards of the anvil, and blades which partition a space in the cylindrical member. Oil is filled in a space defined by the anvil and the cylindrical member, and a plurality of oil chambers are defined by the blades. The cylindrical member is connected to an output shaft of a motor via a speed reduction gear mechanism portion, whereby as the motor rotates at a substantially constant speed, the cylindrical member rotates at a substantially constant speed which is made slower than the rotation speed of the output shaft of the motor. When the cylindrical member is rotating, oil in a predetermined oil chamber is compressed, causing a difference in pressure between the oil chambers. When the anvil rotates so as to eliminate the pressure difference, a pulsed striking torque is generated in the anvil.

Recently, brushless motors have been used as motors for oil pulse tools like the one described in JP-A-2003-291074. Brushless motors are DC (Direct Current) motors without a brush (a commutating brush), in which for example, coils are used at a stator side, while magnets are used at a rotor side, and the coils are energized with an electric power driven by an inverter in a predetermined sequence to rotate the rotor. In such a brushless motor, a switching device for switching on and off the energization of the coils wound round the stator is disposed on a circuit board in the vicinity of the motor. The switching device is disposed on, for example, a substantially circular circuit board which is attached to a rear side (an opposite side to a side where a front end tool is attached) of the motor.

It is known that an advance angle control is performed in a rotation control employing a brushless motor. The advance angle control is a control in which the output torque of a brushless motor is obtained to a maximum extent by regulating an induction voltage of the motor and phases of winding currents. Normally, a maximum toque is provided by the motor when the magnetic field of magnets of the rotor is shifted 90 degrees from the magnetic field of the coils, and in a rotation control employing rotational position detection elements such as Hall elements (or Hall Ic's), a driving voltage is supplied to the windings of the motor as required by using output signals of the rotational position detection elements.

FIG. 6 shows rotating conditions of the brushless motor when an approach is adopted in which the driving voltage is supplied to the windings of the motor as required by employing output signals of the rotational position detection elements, that is, when no advance angle control is used in the rotation control (without advance angle). In the figure, sectional views of the motor at each rotation angles are shown at 121 to 127 in an upper portion, output waveforms of Hall elements H1 to H3 corresponding to the rotation angles of the motor are shown in a center portion, and supply timings of the driving voltage that is supplied to the windings (U-phase, V-phase, W-phase) of the motor are shown in a lower portion. The brushless motor includes a rotor 3a to which permanent magnets 3c are installed and a stator 3b on which coils are disposed. Rotational positions of the rotor 3a are detected by the Hall elements H1 to H3.

FIG. 6 shows a rotation control which is effected “without advance angle” of the driving voltage, and in this control, the permanent magnets 3c of the rotor 3a are attracted by the magnetic fields of the coils situated ahead thereof in the rotating direction, from a position lying 45 degrees before to a position lying 15 degrees before, in terms of rotation angle. In the figure, portions which are shaded by slant lines or in a lattice pattern shows that the driving voltage is supplied to the coils. The windings of the motor become an N pole or an S pole depending on the direction of current flowing thereto. The windings shaded in the lattice pattern denote that the windings are S pole, while the windings shaded by the slant lines denote that the windings are N pole. For example, when the motor is in the condition denoted by 121, the driving voltage is supplied to the U-phase and W-phase windings, whereby the U-phase windings are S pole, and the W-phase windings are N pole, and the permanent magnets 3c facing the windings which are magnetized in such manner are attracted or repelled, and a rotating force is generated in the rotor 3a in a clockwise direction indicated by an arrow in the figure. In the brushless motor configured as shown in FIG. 6, an angle over which the permanent magnets 3c and the coils overlap under the same pole is 30 degrees in terms of rotation angle of the rotor 3a.

The Hall elements H1 to H3 are disposed axially rearwards (or forwards) of the rotor 3a with a predetermined interval (60 degrees in terms of rotation angle in this exemplary embodiment) defined therebetween. The Hall elements H1 to H3 are magnetic sensors which make use of the Hall effect and convert magnetic fields generated by the permanent magnets 3c into electric signals so as to obtain predetermined output signals (output voltages). Output waveforms of the Hall elements H1 to H3 are shown in the center portion of FIG. 6. For example, in an output signal 131 of the Hall element H1, the output becomes HIGH (facing the N pole) from 0 degrees to 30 degrees and from 120 degrees to 180 degrees in terms of rotational angle of the rotor 3a and becomes LOW (facing the S pole) from 30 degrees to 120 degrees. Similarly, the Hall elements H2, H3 also generate output signals 132, 133, respectively, in accordance with the magnetic poles of the permanent magnets 3c which they face. The Hall elements H1 and H2, and H2 and H3 are disposed so as to be shifted 60 degrees in terms of rotation angle from each other, and therefore, the output signals 132, 133 are shifted 60 degrees and 120 degrees from the output signal 131, respectively.

The U-phase, V-phase and W-phase windings of the stator 3b are connected into Y-connection, and the driving voltage is supplied to a predetermined phase based on the rise of signals from the Hall elements H1 to H3. A driving voltage 137 is supplied in a direction in which the V-phase windings becomes an S pole, from a rise (LOW to High) of the Hall element H1 to a rise (LOW to HIGH) of the Hall element H2 (which corresponds to 60 degrees in terms of rotor angle). In addition, a driving voltage 136 is supplied in a direction in which the V-phase windings becomes an N pole, from a fall (HIGH to LOW) of the Hall element H1 to a fall (HIGH to LOW) of the Hall element H2 (which corresponds to 60 degrees in terms of rotor angle).

A driving voltage 135 is supplied in a direction in which the U-phase windings becomes an N pole, from a fall (HIGH to LOW) of the Hall element H2 to a fall (HIGH to LOW) of the Hall element H3 (which corresponds to 60 degrees in terms of rotor angle). In addition, a driving voltage 134 is supplied in a direction in which the U-phase windings becomes an S pole, from a rise (LOW to HIGH) of the Hall element H2 to a rise (LOW to HIGH) of the Hall element H3 (which corresponds to 60 degrees in terms of rotor angle).

A driving voltage 139 is supplied in a direction in which the W-phase windings becomes an N pole, from a fall (HIGH to LOW) of the Hall element H3 to a fall (HIGH to LOW) of the Hall element H1 (which corresponds to 60 degrees in terms of rotor angle). In addition, a driving voltage 138 is supplied in a direction in which the W-phase windings becomes an S pole, from a rise (LOW to HIGH) of the Hall element H3 to a rise (LOW to HIGH) of the Hall element H1 (which corresponds to 60 degrees in terms of rotor angle).

The above-described switching of driving voltages is realized by use of a microcomputer and an inverter circuit which are contained in a control circuit. In FIG. 6, only a range from 0 to 180 degrees is shown in terms of rotation angle of the rotor 3a. However, the shape of the rotor 3a is rotationally symmetric and is of dyad symmetry in which the same shape is repeated every 180 degrees. Therefore, controlling conditions from 180 degrees to 360 degrees become the same as the controlling conditions shown in FIG. 6.

Next, a control of the brushless motor “with advance angle” will be described by use of FIG. 7. An example shown in FIG. 7 is an example in which the motor is controlled by setting an advance angle of the driving voltage to 20 degrees. The control of the driving voltage “with advance angle” can be realized by disposing the Hall elements H1 to H3 so as to be offset physically by an angle equal to the advance angle. However, when the driving of the motor is realized by a driving circuit of the microcomputer and the inverter circuit, the control “with advance angle” can be realized by electronically controlling the driving of the motor.

In FIG. 7, sectional conditions of the motor indicated by arrows 121 to 127 show conditions of the motor which result when the motor rotates every 30 degrees and are the same as those shown in FIG. 6. In addition, the positions of the Hall elements H1 to H3 are the same as those shown in FIG. 6. Therefore, output signals 61 to 63 which are outputted from the Hall elements H1 to H3, respectively, have signal waveforms which are the same as the output signals 131 to 133 in FIG. 6. Also in FIG. 7, the driving voltage is supplied to one of those phases which is predetermined based on the rise of signals from the Hall elements H1 to H3. However, timings at which driving voltages 64 to 69 are caused to flow are advanced by 20 degrees further ahead than the timings shown in FIG. 6. By adopting this configuration, the start of supply of the driving voltages to the windings is advanced by 20 degrees and the stop of supply thereof is advanced by 20 degrees.

A driving voltage 67 is supplied in a direction in which the V-phase windings becomes an S pole at a timing 20 degrees ahead of a rise (LOW to HIGH) of the Hall element H1, and a driving voltage 66 is supplied in a direction in which the V-phase windings becomes an N pole at a timing 20 degrees ahead of a fall (HIGH to LOW) of the Hall element 1. A length (in time) over which the driving voltages 66, 67 are supplied corresponds to 60 degrees in terms of rotation angle of the rotor 3a. Similarly, a driving voltage 65 is supplied in a direction in which the U-phase windings becomes an N pole at a timing 20 degrees ahead of a fall (HIGH to LOW) of the Hall element H2, and a driving voltage 64 is supplied in a direction in which the U-phase windings becomes an S pole at a timing 20 degrees ahead of a rise (LOW to HIGH) of the Hall element 2. Further, a driving voltage 69 is supplied in a direction in which the W-phase windings becomes an N pole at a timing 20 degrees ahead of a fall (HIGH to LOW) of the Hall element H3, and a driving voltage 68 is supplied in a direction in which the W-phase windings becomes an S pole at a timing 20 degrees ahead of a rise (LOW to HIGH) of the Hall element 3. The switching of the driving voltages described above is realized by use of the microcomputer and the inverter circuit contained in the control circuit.

When the driving voltages are controlled “with advance angle” as described referring to FIG. 7, the permanent magnets 3c of the rotor 3a are attracted from <45 degrees+advance angle> (65 degrees in this example) before to <15 degrees+advance angle> (35 degrees in this example) before, by the coils situated ahead thereof in the rotating direction. The rotor 3a is attracted by the coils situated further ahead thereof, as a result of which a maximum rotation speed of the rotor 3a is increased. On the other hand, this calls for a reduction in torque because the attraction force which attracts the rotor 3a in the rotating direction is small, when the rotor 3a is rotating at low speeds where the inertial force of the rotor 3a is small. Further, the angle over which the permanent magnets 3c and the coils overlap under the same pole is increased to 50 degrees in terms of rotation angle of the rotor 3a. Due to the rotor 3a getting near to a position where the same poles face each other, the fluctuation in torque of the motor, which depends on the position of the rotor 3a, increases.

The inventors, etc., conducted various experiments so as to apply the advance angle control to the control of the motor of the oil pulse tool, which is an example of the power tool, and found out that the maximum rotation speed increases and the angular velocity of the liner increases when a pulse is generated, by controlling the driving voltages of the motor with an advance angle. As a result, the striking torque can be increased and the increase in tightening torque can be attained. On the other hand, it is also found out that when the driving voltages are controlled with the advance angle, the re-actuating torque is disadvantageously reduced when re-actuating the motor after the motor has been locked. Further, it is found out that depending on the stopping position of the rotor (the position of the rotor relative to the stator) when the motor is locked, the fluctuation in actuating characteristics becomes large, leading to fears that the motor cannot be actuated stably.

This is because since the control of the motor employing the advance angle control is a control in which the magnetic fields generated in the coils are changed by predicting the position of the rotor on the assumption that the rotor rotates based on inertial force, when in a locked state (the rotor is stopped rotating), the magnetic fields of the coils become unsuited to the corresponding magnets of the rotor depending on the stopping position of the rotor. This means that, when re-accelerating the rotor which is almost stopped or which has started to rotate in the reverse direction after striking is effected, acceleration of the rotor varies depending on the stopping position of the rotor. As a result, the rotation speed of the liner fluctuates next time the striking is performed, leading to variation in the striking torque or the tightening torque.

FIG. 8 is a chart showing output characteristics resulting when the motor starts to rotate with and without advance angle control. In the figure, a solid line indicates an exemplary diagram showing a relationship between rotation speed and torque of the motor when the advance angle control is not adopted (without advance angle), in which an axis of abscissas denotes rotation speed of the motor and an axis of ordinates denotes torque (N·m) thereof On the other hand, a curve indicated by a dotted line in the figure indicates a relationship between rotation speed and torque of the motor when the advance angle control is adopted (with advance angle). It can be understood from this chart that torque becomes higher without advance angle than with advance angle when the rotation speed of the motor is low, and this relationship is reversed when the rotation speed is increased, whereby torque becomes higher with advance angle than without advance angle, and the maximum rotation speed is also increased. The inventors, etc., studied about a control in which the advance angle is changed in accordance with the rotation speed of the motor by making effective use of the characteristics of the controls with advance angle and without advance angle.

Aspects of the invention have been made in view of the situations, and an object thereof is to attain a stable operation in a power tool which employs a brushless motor. In addition, an object of an exemplary embodiment of the invention is to attain a stable tightening operation in an oil pulse tool which employs a brushless motor.

Another object of the invention is to increase the tightening torque through advance angle control and to provide an oil pulse tool which solves a problem of variation in tightening torque.

A further object of the invention is to provide an oil pulse tool which can actuate a motor in a locked state stably by changing the advance angle of the driving voltage of the motor in accordance with the rotation thereof.

### SUMMARY

Representative characteristics of the invention which are disclosed in this patent application will be as follows.

According to an aspect of the invention, there is provided an oil pulse tool including: a brushless motor which includes stator windings; a drive circuit configured to apply a driving voltage to any of the stator windings of the brushless motor at a predetermined timing; an oil pulse mechanism portion configured to be rotary driven by the brushless motor; and an output shaft which is connected to the oil pulse mechanism portion, wherein the drive circuit changes an advance angle of the driving voltage in accordance with a rotational position of the oil pulse mechanism portion.

According to another aspect of the invention, there is provided an oil pulse tool including: a brushless motor which includes stator windings; a drive circuit configured to apply a driving voltage to any of the stator windings of the brushless motor at a predetermined timing; an oil pulse mechanism portion configured to be rotary driven by the brushless motor; and an output shaft which is connected to the oil pulse mechanism portion, wherein the drive circuit controls the driving voltage with a fixed advance angle until a first striking is started, and wherein the drive circuit controls the driving voltage with a variable advance angle, in which the advance angle of the driving voltage is changed in accordance with a rotation angle of the oil pulse mechanism portion, after the first striking is started.

According to another aspect of the invention, there is provided a power tool including: a brushless motor; a rotary striking mechanism portion configured to be driven by the brushless motor; and an output shaft connected to the rotary striking mechanism portion, wherein an advance angle of a driving voltage applied to the brushless motor is changed in accordance with a rotational position of the rotary striking mechanism portion.

According to another aspect of the invention, there is provided a power tool including: a brushless motor; a striking mechanism portion configured to be driven by the brushless motor; and an output shaft connected to the striking mechanism portion, wherein an advance angle of a driving voltage applied to the brushless motor is changed in accordance with a position of the striking mechanism portion.

According to another aspect of the invention, there is provided a power tool including: a brushless motor; and an output shaft configured to be driven by the brushless motor, wherein a load on the output shaft fluctuates periodically, wherein, when the load on the output shaft is a low load, an advance angle of a driving voltage applied to the brushless motor is a first advance angle, and wherein, when the load on the output shaft is a high load, the advance angle of the driving voltage applied to the brushless motor is a second advance angle which is smaller than the first advance angle.

### BRIEF DESCRIPTION OF DRAWINGS

FIG. 1 is a side view (a partially sectional side view) showing an overall configuration of an oil pulse tool 1 according to an exemplary embodiment of the invention;

FIG. 2 shows sectional views of the oil pulse tool 1 taken along the line A-A in FIG. 1 which represent eight stages of a rotation of an oil pulse mechanism portion 20 when in use;

FIG. 3 is a schematic block diagram of the oil pulse tool 1 according to the exemplary embodiment of the invention;

FIG. 4 is a timing chart of a control of a motor of the oil pulse tool 1 according to the exemplary embodiment of the invention;

FIG. 5 is a flowchart showing a control procedure of the oil pulse mechanism portion 20 according to the exemplary embodiment of the invention;

FIG. 6 is a chart showing a control of the brushless motor without advance angle;

FIG. 7 is a chart showing a control of the brushless motor with advance angle;

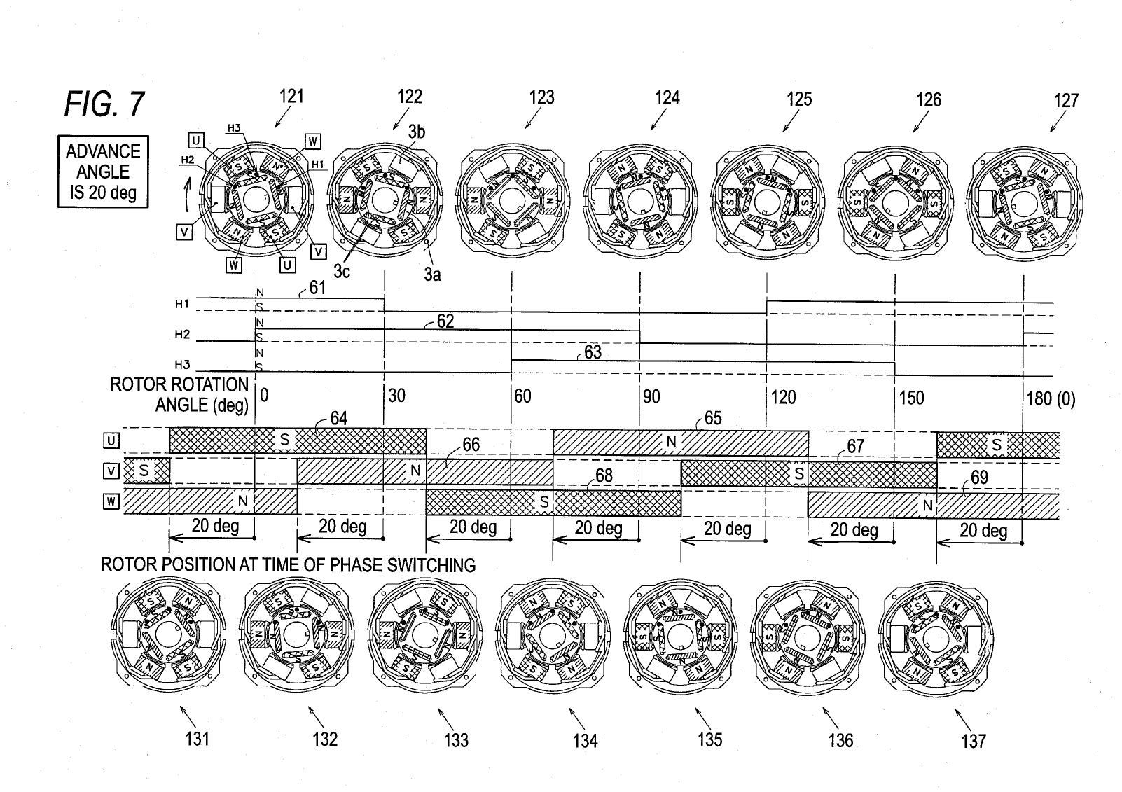

FIG. 8 is a chart showing output characteristics when the motor starts to rotate with and without advance angle; and

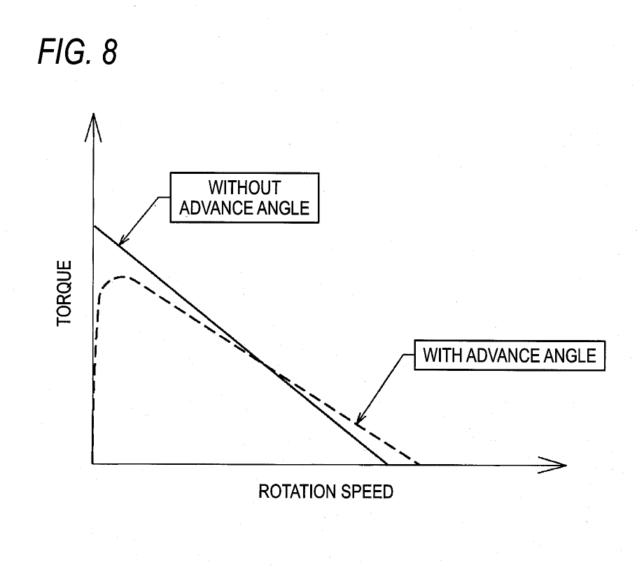

FIG. 9 is a timing chart of a control of the motor of the oil pulse tool with and without advance angle.

### DETAILED DESCRIPTION

### Exemplary Embodiment 1

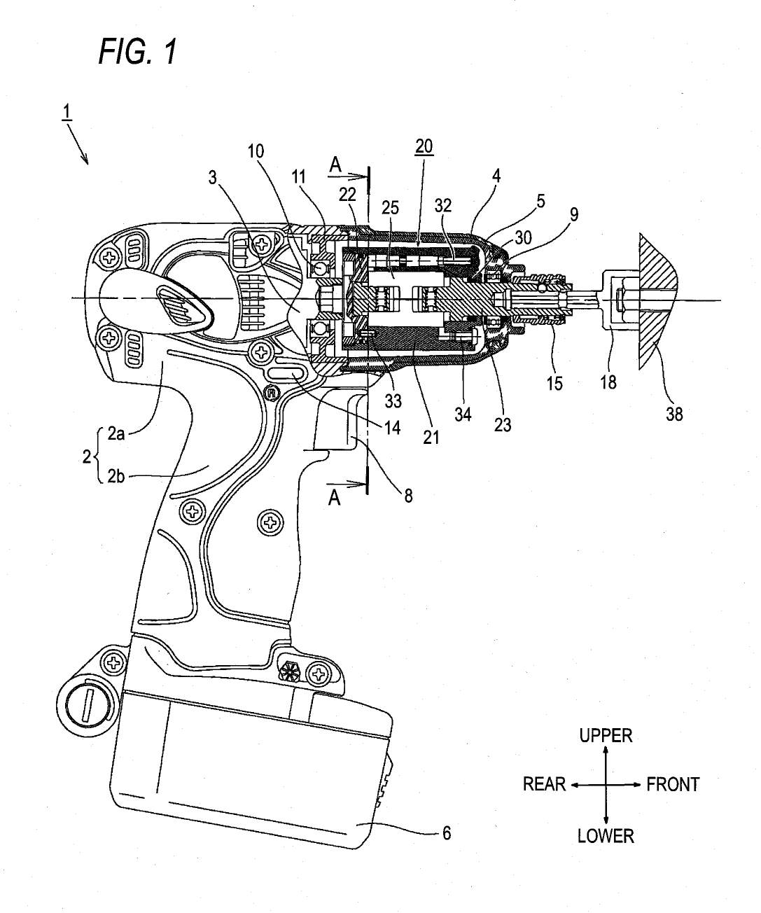

Hereinafter, an exemplary embodiment of the invention will be described by reference to the accompanying drawings. Note that when directions are described in this specification, they refer to upper, lower, front and rear directions shown in FIG. 1, respectively.

In FIG. 1, an oil pulse tool 1 drives an oil pulse mechanism portion 20 by using a motor 3 accommodated within a housing 2 as a drive source and by using electric power supplied by a battery 6. The oil pulse mechanism portion 20 has a main shaft (an anvil) which functions as an output shaft and performs a screwing operation of screwing a bolt or a screw into a material to be fastened by imparting rotating rotary striking forces to the main shaft to thereby transmit the rotary striking forces directly or indirectly to a front end tool 18. In the exemplary embodiment, a rotational shaft of the motor 3 is connected directly to an input portion of the oil pulse mechanism portion 20 without interposing a speed reduction gear mechanism therebetween. Consequently, the motor 3 and a liner 21 of the oil pulse mechanism portion 20 rotate at the same speed in a synchronous manner. The oil pulse tool 1 of the exemplary embodiment is driven by the motor 3 which is driven by the rechargeable battery 6, and the rotational driving of the motor 3 is controlled by a control circuit installed on a circuit board, not shown, within the oil pulse tool 1. The power supply to drive the motor 3 is not limited to the battery 6, and hence, the motor 3 may be rotated by a commercial alternating current power supply. In addition, in this exemplary embodiment, the oil pulse mechanism portion 20 is connected directly to the rotational shaft of the motor 3. However, the oil pulse mechanism portion 20 may be driven via a speed reduction gear mechanism employing, for example, a planetary gear mechanism, which is disposed on an output side of the motor 3.

Electric power supplied to the battery 6 is, for example, a direct current electric power of 14V which is sent to the motor 3 via an inverter circuit, which will be described later. The motor 3 is a known brushless motor, which has a stator having windings wound round a stator core on an outer circumferential side thereof and a rotor having permanent magnets on an inner circumferential side thereof, and is driven by the inverter circuit, which will be described later. The housing 2 is made up of a cylindrical body portion 2a which accommodates the motor 3 and a grip portion 2b which extends downwards from the body portion in a normal direction. The grip portion 2b is a portion which is gripped by an operator, and a trigger switch 8 is provided at a front of an upper portion of the grip portion 2b. When the operator pulls on the trigger switch 8 while gripping on the grip portion 2b, a driving electric power is transmitted to the motor 3 in substantially proportion to the amount by which the trigger switch 8 is pulled. The battery 6 is detachably attached to a lower end of the grip portion 2b, that is, to an end of the grip portion 2b which is opposite to an end which faces the motor 3 (an opposite-to-motor end).

The oil pulse mechanism portion 20 which constitutes a striking force generation mechanism, the main shaft 23 of the oil pulse mechanism portion 20 and a bit holder 15 are positioned on an extension (an axis) of the rotational shaft of the motor 3. In this exemplary embodiment, a speed reduction gear mechanism, which is generally provided in a powered oil pulse tool, is not present on the axis of the rotational shaft of the motor 3. In this way, only minimum required parts are disposed on the rotational axis of the motor 3, and therefore, a front-to-rear length (overall length) of the oil pulse tool can be made short, thereby making it possible to realize a reduction in size of the oil pulse tool to increase the operability thereof greatly.

The oil pulse mechanism portion 20, functioning as the rotary striking mechanism, is accommodated inside a case 4 connected to a distal end of the housing 2. A shaft portion of the oil pulse mechanism portion 20 which project rearwards and in which a liner plate 22 is fitted is connected directly to the rotational shaft of the motor 3 without interposing a speed reduction gear mechanism or the like therebetween. An outer circumferential surface of the case 4 is covered with a cover 5 made of a resin material. A rear side of a central shaft of the liner plate 22 is formed into a fitting shaft having a hexagonal cross-sectional shape, and this fitting shaft is installed in a fitting hole formed in the rotational shaft of the motor 3. The main shaft 23 of the oil pulse mechanism portion 20 which extends forwards functions as an output shaft of the oil pulse mechanism portion 20, and a known bit holder portion such as the bit holder 15 is formed at a distal end portion thereof The oil pulse mechanism portion 20 is supported in a holder 11 via a bearing 10 at a rear end portion thereof and is held in the case 4 via a bearing 9 at a front end portion thereof. In this exemplary embodiment, the bearing 9 is a ball bearing, however, other bearings such as a needle bearing and a metal bearing can also be used.

The front end tool 18 can be installed in the bit holder 15. In the example shown in FIG. 1, although a hexagonal socket for screwing a bolt attached to a material to be fastened is shown as an example of a front end tool 18, the front end tool 18 to be installed is not limited to the hexagonal socket, and hence, a driver bit or other front end tools can also be installed. When the trigger switch 8 is pulled to actuate the motor 3, a rotational force of the motor 3 is transmitted to the oil pulse mechanism portion 20, and the liner 21 of the oil pulse mechanism portion 20 rotates at the same speed as the rotation speed of the motor 3.

Oil is filled inside of the oil pulse mechanism portion 20, and when no load is exerted on the main shaft 23 or the load is small, only a resisting force of the oil is exerted on the main shaft 23, which rotates in almost synchronism with the rotation of the motor 3. When a large load is exerted on the main shaft 23, the main shaft 23 stops rotating, and only the liner 21 on the outer circumferential side of the oil pulse mechanism portion 20 continues to rotate. The pressure of the oil is drastically increased in a position where the oil pulse mechanism portion 20 is closed so as to prohibit the egress and ingress of the oil only once during a full rotation of the liner 21, whereby a large tightening torque (a striking force) is applied to the main shaft 23 so as to rotate the main shaft 23 with a large force. Thereafter, the same impact operation is repeated several times, so that the striking force is transmitted to the main shaft 23 intermittently and repeatedly until an object to be fastened is fastened with a torque set.

The oil pulse mechanism portion 20 is configured so that oil is filled to be kept contained in a closed fashion within a cavity defined within the liner 21 which is rotated by the motor 3, two axial grooves are provided in the main shaft (the output shaft) 23 which is fittingly inserted in the liner concentrically and blades 25 are fittingly inserted into the axial grooves so that the blades 25 are biased at all times in an outer circumferential direction of the main shaft 23 by elastic means such as springs so as to be brought into abutment with the liner 21. An O-ring 30 is provided at a sliding portion between the main shaft 23 and the liner 21 so as to prevent the leakage of the oil kept contained in the cavity in the liner 21. When the liner 21 is driven to rotate and a seal portion formed on an inner circumferential surface of the liner 21 coincides with a seal portion formed on an outer circumferential surface of the main shaft, a pressure difference is generated in the oil pulse mechanism portion 20, whereby a striking torque is generated intermittently in the main shaft 23.

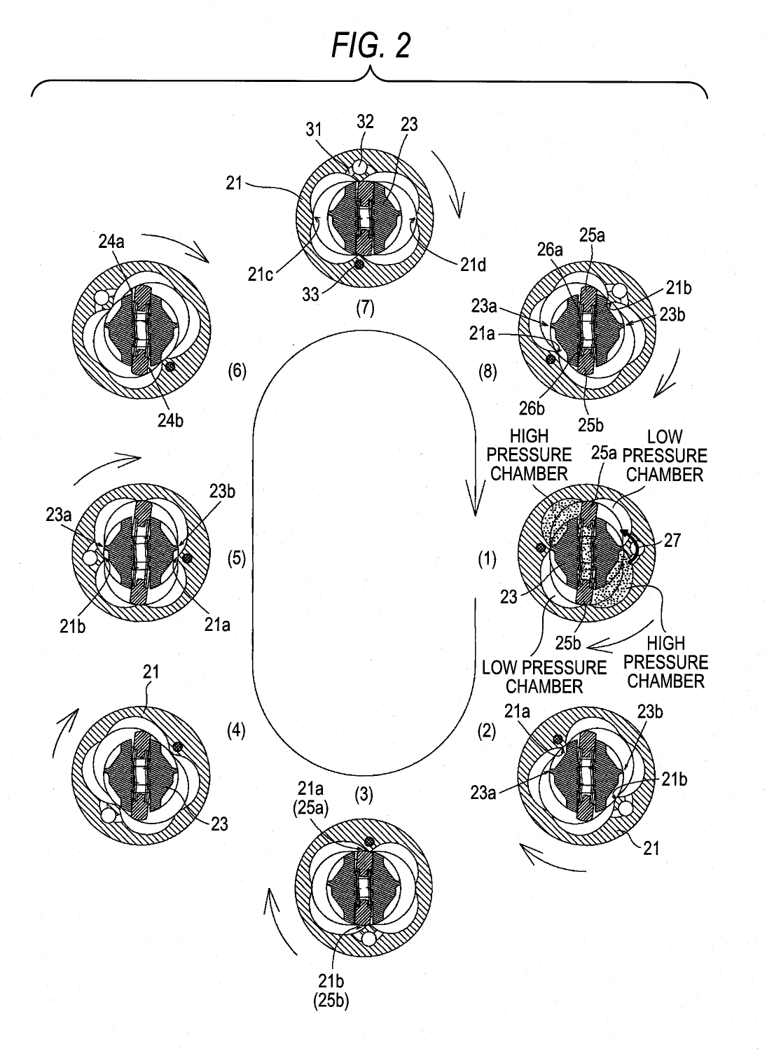

Next, the operation of the oil pulse mechanism portion 20 will be described further by reference to FIG. 2. Parts (1) to (8) in FIG. 2 show sections of the oil pulse mechanism portion 20 taken along the line A-A in FIG. 1, which show conditions occurring therein while the liner 21 rotates a full rotation at relative angles with respect to the main shaft 23. Firstly, before starting to describe the operating procedure, the construction of the oil pulse mechanism portion 20 will be described by reference to the parts (6) to (8) in FIG. 2.

The oil pulse mechanism portion 20 is made up mainly of two portions which are a driving portion which rotates in synchronism with the motor 3 and an output portion which rotates in synchronism with the main shaft 23 to which the front end tool is attached. The driving portion which rotates in synchronism with the motor 3 includes the liner plate 22 (see FIG. 1) which is connected directly to the rotational shaft of the motor 3 and the substantially cylindrical, monolithically molded liner 21 which is fixed so as to extend to the front on the outer circumferential side of the liner plate 22. The output portion which rotates in synchronism with the main shaft 23 includes the main shaft 23 and the two axial grooves 24a, 24b which are formed at angular intervals of 180 degrees in the main shaft 23. The two axial grooves 24a, 24b are provided to the main shaft 23 so as to be formed at angular intervals of 180 degrees. The axial grooves 24a, 24b are grooves which are provided parallel to the axial direction in positions on the outer circumferential side of the main shaft 23 which are spaced 180 degrees apart from each other. The length of the axial grooves 24a, 24b is almost the same as an axial length of an inner wall of the liner 21. The blades 25a, 25b are fittingly inserted into the axial grooves 24a, 24b, respectively, so that the blades 25a, 25b are biased towards the outer circumferential direction of the main shaft 23 at all times by the elastic means such as springs 26a, 26b so as to contact with the inner circumferential wall of the liner.

Projecting seal surfaces 23a, 23b are formed in positions on the main shaft 23 which are spaced about 90 degrees in terms of rotation angle apart from the positions where the blades 25a, 25b are attached, respectively. Two projecting seal surfaces 21a, 21b are formed on an inner circumferential side of the liner 21 which project into an interior of the liner 21 so as to be brought into substantial contact with the projecting seal surfaces 23a, 23b, respectively. When the projecting seal surfaces 23a, 23b are situated in positions where they face the projecting seal surfaces 21a, 21b, respectively, the blades 25a, 25b are brought into abutment with projecting portions 21c, 21d, respectively.

The main shaft 23 is held so as to rotate within a closed space defined by the liner 21 and the liner plate 22, and oil (operating oil) is filled in the closed space so as to generate torque. The O-ring 30 (refer to FIG. 1) is provided between the liner 21 and the main shaft 23 so as to ensure airtightness between the liner 21 and the main shaft 23. An oil passage 31 and a regulator valve 32 are provided at one circumferential location on the liner 21 so as to relieve the pressure of the oil from a high pressure chamber to a low pressure chamber, so that a generated maximum pressure of the oil is suppressed so as to regulate a tightening torque. In addition, a pin 33 which registers the mounting position of the liner 21 and the liner plate 22 is provided at a different circumferential location on the liner 21.

Next, the operation of the oil pulse mechanism portion will be described in the order of the parts (1) to (8) in FIG. 2. The parts (1) to (8) in FIG. 2 show the liner 21 rotating a full revolution with respect to the main shaft 23 at relative angles. The motor 3 rotates when the trigger switch 8 is pulled, and the liner 21 also rotates in synchronism with the rotation of the motor 3. The rotating direction of the liner 21 is indicated by arrows shown on outer sides of the liners 21 shown in the parts (1) to (8) in FIG. 2. As described before, the main shaft 23 follows the rotation of the liner 21 (synchronously) against only a resisting force of the oil when no load is exerted on the main shaft 23 or when the load exerted thereon is small. The main shaft 23 stops rotating when a large load is exerted on the main shaft 23, and only the liner 21 lying on the outer side of the main shaft 23 continues to rotate.

The part (1) of FIG. 2 is the view showing a positional relationship between the liner 21 and the main shaft 23 when a striking force is generated in the main shaft 23, and in this exemplary embodiment, a rotation angle of the liner 21 with respect to the main shaft 23 is defined as 0 degrees in a situation shown in the part (1). A position of the liner 21 shown in the part (1) is a position where the oil is kept contained in a closed fashion within the liner 21, which occurs once in a full rotation of the liner 21. In this position, the projecting seal surface 21a abuts with the projecting seal surface 23a, the projecting seal surface 21b abuts with the projecting seal surface 23b, the blade 25a abuts the projecting portion 21c, and the blade 25b abuts the projecting portion 21d, over the whole area of the main shaft 23 in the axial direction, whereby an interior space in the liner 21 is divided into two high pressure chambers and two low pressure chambers.

Here, high pressure and low pressure denote the pressure of the oil present in the interior of the liner 21. Further, when the liner 21 rotates in association with the rotation of the motor 3, the oil present in the high pressure chamber flows from the high pressure chamber into the low pressure chamber via the oil passage 31 and the regulator valve 32. This reduces the volume of the oil in the high pressure chamber, and therefore, the oil is compressed and a high pressure is generated momentarily. This high pressure pushes the blades 25 towards the low pressure chambers. As a result, a force is applied momentarily to the main shaft 23 via the upper and lower blades 25a, 25b, generating a strong rotational torque. By the formation of the high pressure chambers, a strong striking force is applied to the blades 25a, 25b which rotates them in a clockwise direction in the figure. In this specification, the position where the rotation angle of the liner 21 is 0 degrees shown in the part (1) is referred to as a “striking position.”

The part (2) of FIG. 2 shows a condition where the liner 21 has rotated 45 degrees from the striking position. The abutment between the projecting seal surface 21a and the projecting seal surface 23a, the projecting seal surface 21b and the projecting seal surface 23b, the blade 25a and the projecting portion 21c, and the blade 25b and the projecting portion 21d are released when the liner 21 rotates to pass by the striking position shown in the part (1). Therefore, the four chambers which are defined in the interior space in the liner 21 are no more present, and the oil flows through the space which is no more divided. Thus, no torque is generated, and the liner 21 rotates further in association with the rotation of the motor 3.

The part (3) of FIG. 2 shows a condition where the liner 21 has rotated 90 degrees from the striking position. In this condition, the blades 25a, 25b abut with the projecting seal surfaces 21a, 21b, respectively, and are withdrawn radially inwards to positions where the blades 25a, 25b do not project from the main shaft 23. Therefore, the liner 21 receives no influence of the oil pressure and hence, no torque is generated, whereby the liner 21 continues to rotate.

The part (4) of FIG. 2 shows a condition where the liner 21 has rotated 135 degrees from the striking position. In this condition, the interior spaces in the liner 21 are in communication with each other, and no change in the pressure of the oil is generated, and therefore, no rotation torque is generated in the main shaft 23.

The part (5) of FIG. 2 shows a condition where the liner 21 has rotated 180 degrees from the striking position. In this condition, the projecting seal surface 21b approaches the projecting seal surface 23a, and the projecting seal surface 21a approaches the projecting seal surface 23b. However, neither the projecting seal surface 21b and the projecting seal surface 23a nor the projecting seal surface 21a and the projecting seal surface 23b abut with each other. This is because the projecting seal surface 23a and the projecting seal surface 23b are not situated in symmetrical positions with respect to an axis of the main shaft 23. Similarly, the projecting seal surfaces 21a and 21b which are formed on the inner circumference of the liner 21 are not situated in symmetrical positions with respect to the axis of the main shaft 23, either. Consequently, the liner 21 is not almost affected by the oil in this position, and therefore, almost no torque is generated (however, since torque is generated slightly, the sliding resistance of the liner 21 is increased slightly). The reason that the torque generated is not zero is that the oil filled in the interior of the liner 21 has a viscosity, and when the projecting seal surface 21b faces the projecting seal surface 23a or the projecting seal surface 21a faces the projecting seal surface 23b, high pressure chambers are formed although only to a slight extent. Therefore, being different from the conditions showed in the parts (2) to (4) and (6) to (8), a slight rotational torque is generated.

The conditions showed in the parts (6) to (8) of FIG. 2 are almost the same as the parts (2) to (4), and no torque is generated in these conditions. The liner 21 returns to the condition showed in the part (1) of FIG. 2 when the liner 21 rotates further from the condition showed in the part (8) of 2. A pressure generated in the high pressure chamber in the striking position in the part (1) of FIG. 2 passes through the oil passage 31 and flows into the low pressure chamber by way of the regulator valve 32. The pressure in the high pressure chamber varies depending on the pressure that flew into the low pressure chamber, and the intensity of a striking torque generated is regulated. Namely, the oil in the high pressure chamber flows into the low pressure chamber quickly when the opening area of the regulator valve 32 is expanded, and the pressure in the high pressure chamber decreases. On the contrary, the amount of the oil flowing into the low pressure chamber is reduced when the opening area is narrowed, and the pressure in the high pressure chamber increases.

Thus, as has been described heretofore, in the oil pulse mechanism portion 20, by the relative rotation between the liner 21 an the main shaft 23, a strong striking torque can be generated once in the full revolution of the liner 21, thereby making it possible to rotate the front end tool 18 with a strong tightening torque.

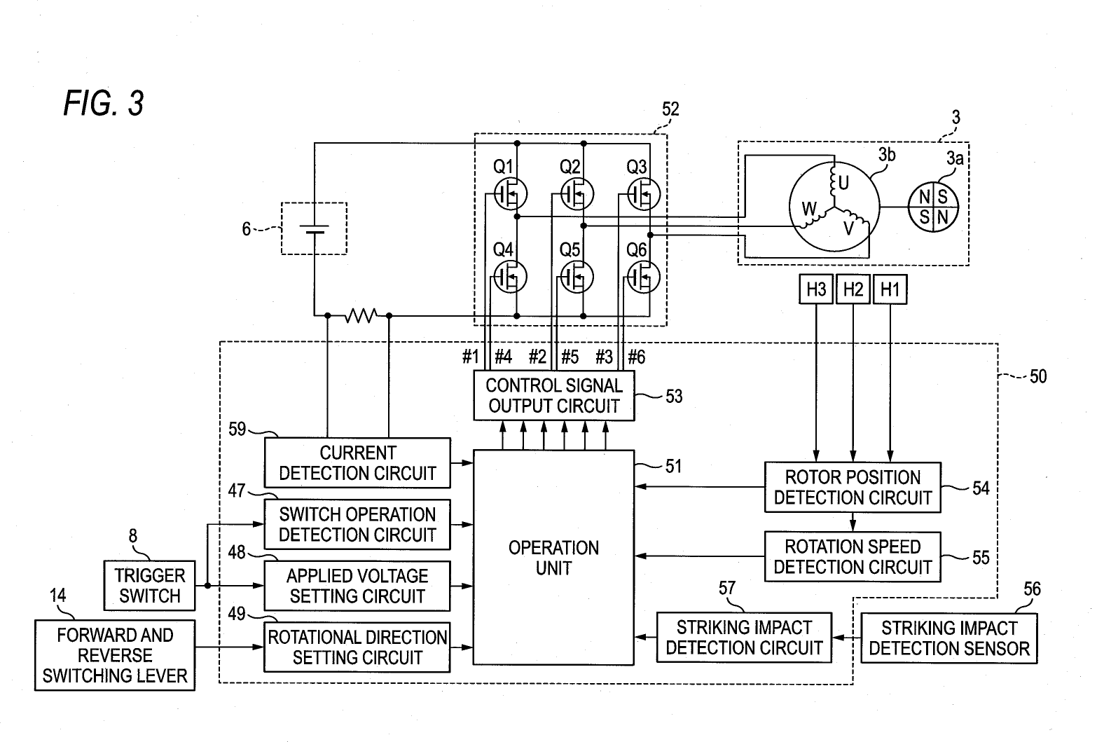

Next, the configuration and function of a drive control system of the motor will be described based on FIG. 3. FIG. 3 is a block diagram showing the configuration of a drive control system of the motor 3, and in this exemplary embodiment, the motor 3 is configured of a three-phase brushless motor. This brushless motor is of a so-called inner rotor type and has the rotor 3a which includes a plurality of sets (two sets) of permanent magnets (magnets) including N poles and S poles, the stator 3b which includes stator windings of three phases, a U-phase, a V-phase and a W-phase, which are connected into the Y-connection, and three Hall elements H1 to H3 which are disposed at predetermined angular intervals of 60 degrees in the circumferential direction for detection of a rotational position of the rotor 3a. A direction in which the stator windings U, V, W are energized and time during which the windings are energized are controlled based on position detection signals from the Hall elements H1 to H3, whereby the motor 3 rotates. The Hall elements H1 to H3 may be disposed on a drive circuit board, not shown, which is provided at the rear of the motor 3. The Hall elements H1 to H3 in this specification are semiconductor elements which generate voltages in accordance with magnetic fields by the Hall effect resulting from the correlation between magnetic field and electric current, and Hall IC's can be used. However, the invention is not limited to these Hall elements, and therefore, other non-contact type position detection devices can also be used.

Elements mounted on the drive circuit board include six switching elements Q1 to Q6 such as FETs (Field Effect Transistors) which are bridge connected in three phases. Respective gates of the six switching elements Q1 to Q6 which are bridge connected are connected to a control signal output circuit 53, and respective drains or sources of the six switching elements Q1 to Q6 are connected to the stator windings U, V, W which are connected into the Y-connection. By this configuration, the six switching elements Q1 to Q6 perform switching operations by switching device driving signals (driving signals such as #4, #5, #6) which are inputted from the control signal output circuit 53 and supply a direct current of the battery 6 that is to be applied to an inverter circuit 52 to the stator windings U, V, W as three phase (U-phase, V-phase and W-phase) voltages Vu, Vv, Vw.

In the switching element driving signals (the three phase signals) which drive the respective gates of the six switching elements Q1 to Q6, the switching element driving signals which drive the three switching elements Q4, Q5, Q6 on a negative power supply side are supplied, and a pulse width (a duty ratio) of a PWM signal is changed based on a detection signal of an operating amount (stroke) of the trigger switch 8 by an operation unit contained in a control unit 50, whereby an electric power supply amount to the motor 3 is regulated to thereby control the actuation/stop and rotational speed of the motor 3.

Here, the PWM signal is supplied either to the switching elements Q1 to Q3 on a positive power supply side or to the switching elements Q4 to Q6 on the negative power supply side of the inverter circuit 52. The PWM signals switch the switching elements Q1 to Q3 or the switching elements Q4 to Q6 at high speeds, as a result of which electric power supplied to the stator windings U, V, W from the direct current voltage of the battery 6 is controlled. In this exemplary embodiment, since the PWM signal is supplied to the negative power supply side switching elements Q4 to Q6, the electric power supplied to the stator windings U, V, W are regulated by controlling the pulse width of the PWM signal, thereby making it possible to control the rotational speed of the motor 3.

A forward-reverse switching lever 14 is provided in the oil pulse tool 1 for switching the rotational direction of the motor 3. A rotational direction setting circuit 49 switches the rotational direction of the motor 3 every time the rotational direction setting circuit 49 detects a change in the forward-reverse switching lever 14 and transmits a control signal thereof to the operation unit 51. Although not shown, the operation unit 51 includes a central processing unit (CPU) for outputting a drive signal based on a processing program and data, a read only memory (ROM) for storing the processing program and control data, a random access memory (RAM) for temporarily storing the data, and a timer.

The control signal output circuit 53 forms driving signals for switching alternately the predetermined switching elements Q1 to Q6 based on output signals from the rotational direction setting circuit 49 and a rotor position detection circuit 54 and output the driving signals so formed to the inverter circuit 52. By this series of operations, the predetermined windings of the stator windings U, V, W are energized alternately, so as to rotate the rotor 3a in a set rotational direction. As this occurs, driving signals applied to the negative power supply side switching elements Q4 to Q6 of the inverter circuit 52 are outputted as PWM modulation signals based on output control signals of an application voltage setting circuit 48. A value of current supplied to the motor 3 is measured by a current detection circuit 59, and the measured value is fed back to the operation unit 51, whereby the value fed back is regulated so as to obtain a set driving electric power. Note that the PWM signal may be applied to the positive power supply side switching elements Q1 to Q3.

A striking impact detection sensor 56 is provided in the oil pulse tool 1, and an output signal of the sensor is transmitted to a striking impact detection circuit 57. The striking impact detection circuit 57 outputs a magnitude of a striking torque detected to the operation unit 51. This enables the operation unit 51 to know a timing at which the striking is performed, that is, a timing at which the relative angle between the liner 21 and the main shaft 23 becomes 0 degrees.

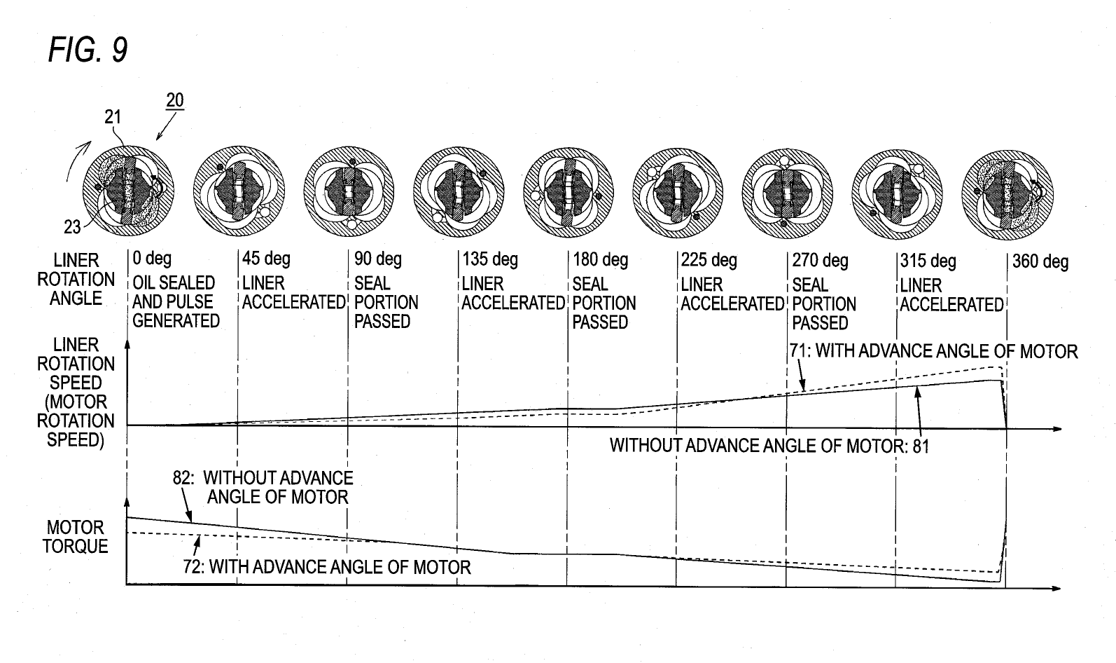

In this exemplary embodiment, an advance angle control is performed based on a relative angle between the liner 21 and the main shaft 23. The advance angle control is a control in which driving signals for switching alternately the switching elements Q1 to Q6 are shifted a predetermined angle to be outputted by regulating a control signal outputted from the operation unit 51 to the control signal output circuit 53. The inventors, etc., studied about a relationship between the rotation speed of the liner 21 and the torque of the motor 3 of the oil pulse tool 1 when the advance angle control is performed and when the advance angle control is not performed in order to perform an optimum control of the oil pulse mechanism portion 20. FIG. 9 is a graph showing a relationship between the rotation speed of the liner 21 and the torque that the motor 3 generates when the rotation angle of the liner 21 changes from 0 degrees to 360 degrees. Positional relationships between the liner 21 and the main shaft 23 at each rotation angles are shown in cross sections in an upper portion.

A graph in a center portion shows the rotation speed of the liner 21 in rpm. Since the liner 21 of this exemplary embodiment is connected directly to the output shaft of the motor 3 with no speed reduction gear mechanism interposed therebetween, the rotation speed of the liner becomes equal to the rotation speed of the motor. A lowermost graph is a graph showing the output torque of the motor 3. Axes of abscissas of the graphs denote the rotation angle of the liner 21 with respect to the main shaft 23.

In FIG. 9, variations in the rotation speed of the liner and the output torque of the motor which result when the control is performed without the advance angle of the motor 3 are indicated by solid lines 81, 82, while variations in the rotation speed of the liner and the output torque of the motor which result when the control is performed with the advance angle of the moor 3 are indicated by dotted lines 71, 72. It is seen from the figure that the output torque of the motor is higher when the motor 3 is controlled without the advance angle of the motor 3 than when the motor 3 is controlled with the advance angle of the motor immediately after the rotation angle of the liner is 0 degrees. The position where the rotation angle of the liner is 0 degrees is the position where pulse is generated (the striking position), and the rotation speed of the motor 3 becomes almost zero due to the generation of pulse. Thus, it is found out that it is preferable that the motor 3 is controlled without advance angle thereof in order to start the motor 3 stably.

On the other hand, at the rotation speeds before striking is performed, for example, in the range of rotation angles of the liner from 270 to 360 degrees, the output torque of the motor can be larger and the rotation speed of the liner can be higher when the motor 3 is controlled with the advance angle of the motor than when the motor 3 is controlled without the advance angle of the motor. Striking is performed in such a state that the rotation speed of the liner is high, and therefore, a larger striking torque can be obtained when the motor 3 is controlled with the advance angle of the motor than when the motor 3 is controlled without the advance angle of the motor. As the result of the experiments, attempting to make use of advantages of both the controls, the inventors, etc., considered that the motor 3 is controlled without the advance angle control of the motor before and after striking is performed and the motor 3 is controlled with the advance angle control of the motor on other occasions.

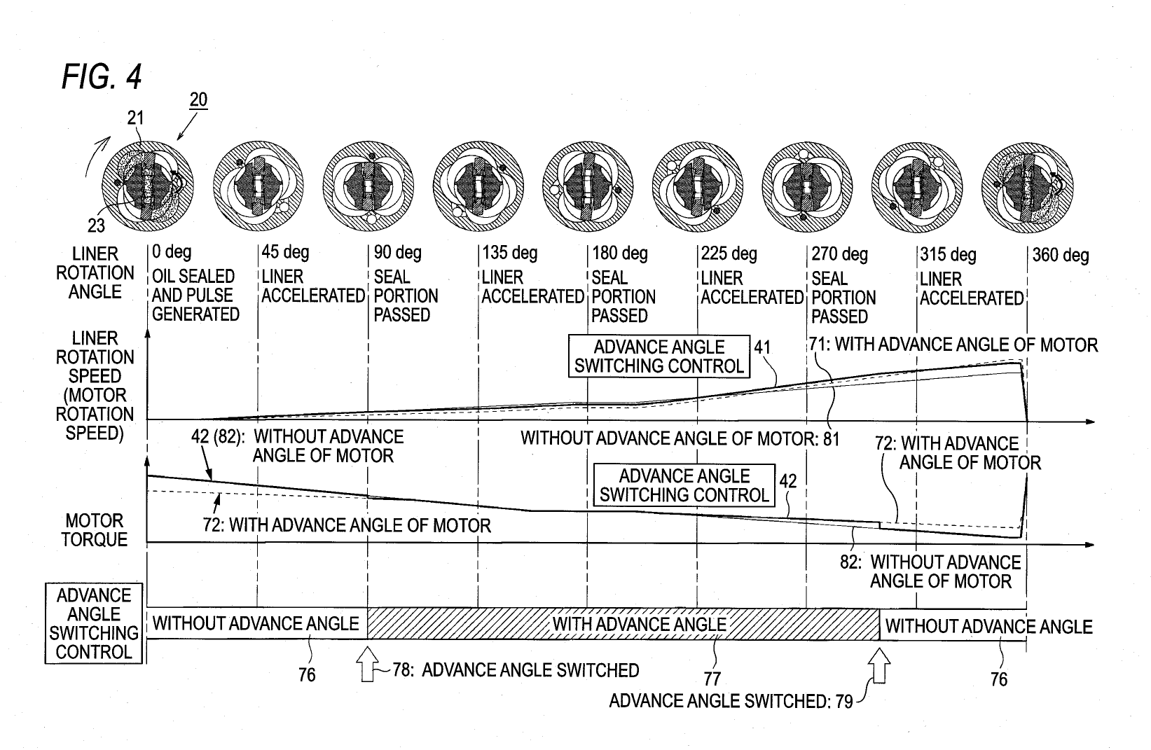

Next, the advance angle control of the motor will be described by reference to FIG. 4. FIG. 4 is a timing chart showing the advance angle control of the motor in the oil pulse tool 1 according to the invention. In this exemplary embodiment, the brushless motor is used as the motor 3, and in order to increase the striking torque, the control of the motor with advance angle is combined (curves 41, 42), which increases the rotation speed of the liner 21 just before striking is performed. Namely, the motor 3 is controlled without advance angle thereof 76 when the rotation angle of the liner 21 is in the range from 0 degrees to 90 degrees and is controlled with advance angle thereof 77 when the rotation angle of the liner 21 is in the range from 90 degrees to 300 degrees. Then, the motor 3 is controlled without advance angle 76 when the rotation angle of the liner 21 is in the range from 300 degrees to 360 degrees. In the event that the motor 3 is controlled in this way, the motor 3 is controlled without advance angle thereof 76 before and after a point when striking is performed (=advance angle of the motor is 0 degrees or 360 degrees, which is a point when a striking torque is generated) and is controlled with advance angle 77 in the rotation angle area where the rotation angle is spaced away from the point in time when striking is performed. By controlling the motor 3 in this way, the rotation speed of the liner 21 just before striking is increased, whereby the striking torque can be increased compared with the case where the motor 3 is controlled only without advance angle throughout the control.

On the other hand, the motor 3 is controlled with the advance angle of the motor set to 0 degrees before and after striking when the rotation angle of the rotor is in the ranges from 0 degrees to 90 degrees and 300 degrees to 360 degrees. This is because the torque is increased at low rotation speeds and the liner 21 is accelerated quickly when striking is performed, that is, from a condition where the liner 21 and the rotor 3a of the motor 3 come to almost a halt (or start to rotate reversely). Normally, in the oil pulse mechanism portion 20, since the sliding resistance of the liner 21 becomes largest at the striking position, it is important that the torque is increased at low rotation speeds in order to accelerate the liner 21. Consequently, when actuating the motor 3, in the event that the motor 3 is controlled with the advance angle of the motor set to 0 degrees (without advance angle), the liner 21 can be started to rotate stably.

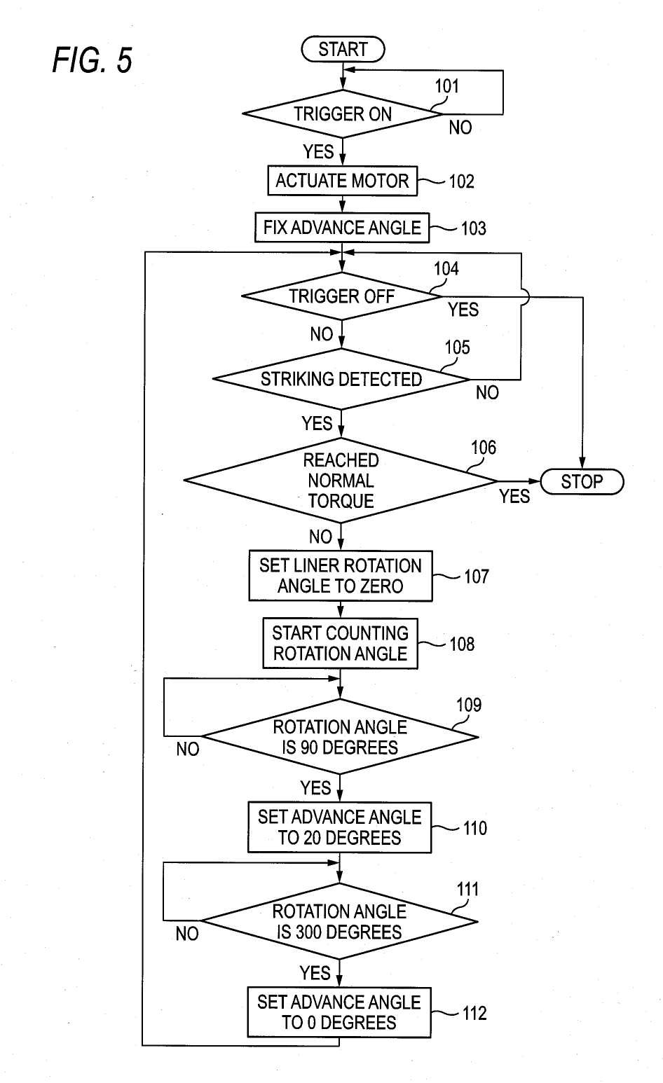

Next, a control procedure of the oil pulse mechanism portion 20 of the exemplary embodiment will be described by reference to a flowchart shown in FIG. 5. A series of operations shown in FIG. 5 can be executed in a software fashion by a program stored in advance angle in the operation unit 51 included in the control unit 50. Firstly, the operator grips on the oil pulse tool 1, positions a bolt or a nut with the front end tool 18 and pulls on the trigger switch 8. The operation unit 51 detects that the trigger switch 8 is pulled (step 101) and actuates the motor 3 by controlling the inverter circuit 52 (step 102). Here, the supply of the driving voltage to the motor 3 is performed with a fixed advance angle, and for example, the motor 3 is controlled without advance angle (advance angle set to 0 degrees) (step 103). Meanwhile, a slight advance angle (for example, smaller than 5 degrees) may be adopted.

Next, the operation unit 51 detects whether or not the trigger switch 8 is switched off, and if the operation unit 51 detects that the trigger switch 8 is off, the motor 3 is stopped and the control of the oil pulse mechanism portion 20 is ended (step 104). In the event that the trigger switch 8 is kept pulled, following this, the operation unit 51 detects whether or not striking is performed by the oil pulse mechanism portion 20, and if the operation unit 51 detects that striking has not yet been performed, the control procedure returns to step 104 (step 105). If it is detected in step 105 that striking has been performed, it is determined whether of not a value of a tightening torque generated by striking reaches a prescribed value (step 106). The measurement of this torque value can be made in the striking impact detection circuit 57 (refer to FIG. 3) based on an output of the striking impact detection sensor 56 (refer to FIG. 3). If it is determined that the value of the tightening torque by striking reaches the prescribed value, the operation is ended based on the understanding that fastening is completed.

If it is determined in step 106 that the value of the tightening torque has not yet reached the prescribed value, the operation unit 51 sets the rotation angle of the liner 21 relative to the main shaft 23 to zero (step 107) and starts counting the rotation angle of the liner 21 thereafter (step 108). In the oil pulse tool 1 of the exemplary embodiment, the output shaft of the motor 3 is connected directly to the liner plate 22, and the liner 21 rotates in synchronism with the rotor 3a of the motor 3. Then, the rotation angle of the liner 21 can be detected by employing output signals of the Hall elements H1 to H3 which are provided in the motor 3. In addition, the rotation angle of the liner 21 may be detected by other methods. There may be adopted a configuration in which a rotation angle sensor is provided on the output shaft or/and the main shaft of the motor 3 so as to detect with high accuracy the rotation angle of the liner 21 relative to the main shaft 23 by making use of an output of the rotation angle sensor.

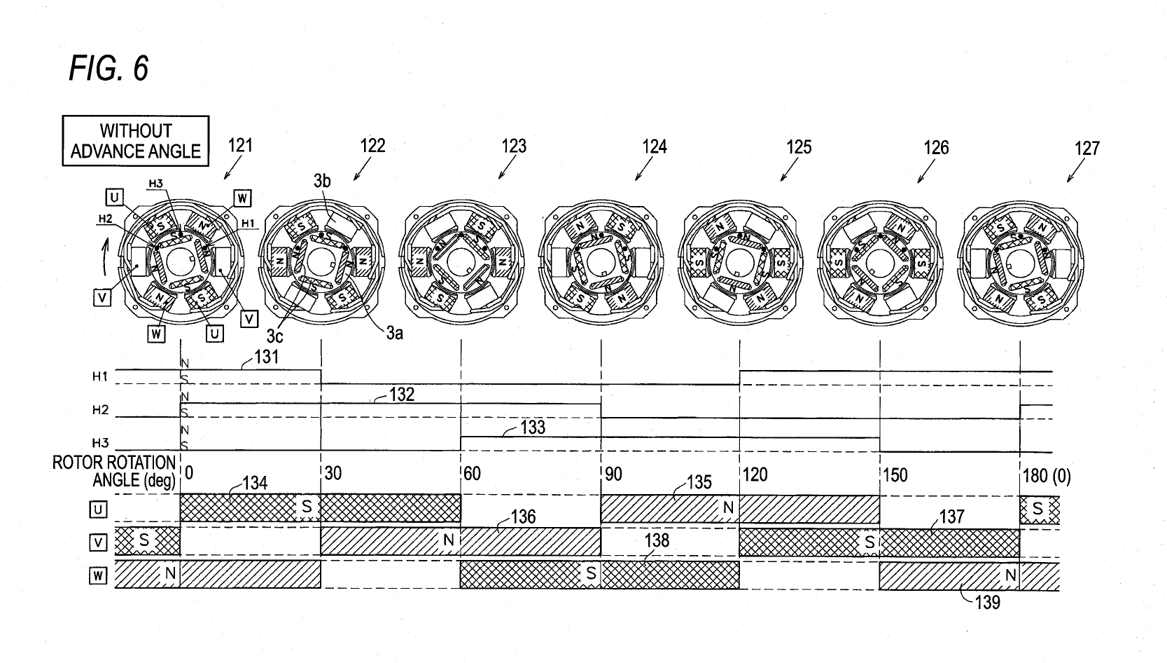

Next, the operation unit 51 determines whether or not the rotation angle of the liner 21 relative to the main shaft 23 reaches 90 degrees (step 109). Since an object to be screwed such as a bolt is seated at this time, even though the liner 21 rotates, the main shaft 23 is kept still. Consequently, the rotation angle of the liner 21 can be detected by detecting the rotation angle of the stator 3a. In step 109, the operation unit 51 waits until the rotation angle of the liner 21 reaches 90 degrees, and when the rotation angle reaches 90 degrees, the operation unit 51 sets the advance angle of the driving voltages, which are supplied to the respective windings of U-phase, V-phase, W-phase of the stator 3b, to 20 degrees. Namely, the control of the motor 3 is switched from the control without advance angle, which has been described by reference to FIG. 6, to the control with the advance angle of 20 degrees (step 110).

The rotation angle of the liner 21 continues to be counted further in the state described above. In step 111, the operation unit 51 waits until the rotation angle of the liner 21 reaches 300 degrees, and when the rotation angle reaches 300 degrees, the operation unit 51 sets the advance angle of the driving voltages which are supplied to the respective windings of U-phase, V-phase, W-phase of the stator 3b to 0 degrees, that is, the operation unit 51 sets the control of the motor to the control without advance angle, and the control procedure returns to step 104.

By the control that has been described heretofore, the driving of the motor 3 is controlled with the fixed advance angle thereof until a first striking is performed (an impact pulse is generated) by the oil pulse mechanism portion 20 and after the first striking is performed, the driving of the motor 3 is controlled by changing the advance angle of driving voltages in accordance with the rotation angle of the liner 21. In this way, by changing the advance angle of the driving voltages, the rotation speed of the liner just before striking is increased, thereby making it possible to increase the tightening torque when striking is performed. In addition, the driving of the motor 3 is controlled without advance angle before and after striking, and therefore, the actuating torque or low-speed torque when the rotor 3a is stopped or is rotated at extremely low speeds immediately after striking is performed can be increased, thereby making it possible to improve largely the actuating and acceleration characteristics of the motor 3. As a result of this, as is indicated by curves 41, 42 in FIG. 4, the rotation speed of the liner shows a behavior intermediate between the behavior resulting when the control with advance angle is performed throughout the control of the driving of the motor and the behavior resulting when the control without advance angle is performed throughout the control of the driving of the motor.

When the rotation angle of the rotor stays between 300 degrees and 360 degrees, the maximum rotation speed is increased, and a large striking torque can be obtained. However, because the advance angle control is such that the poles of the coils are switched by predicting the position of the rotor 3a, a prediction error of the rotor position can occur at the time of striking. In addition, the prediction error in the striking position may result in a situation where acceleration continues with the advance angle kept set even after striking. Because of this, in order to ensure that the advance angle becomes 0 degrees in the striking position, the advance angle is switched to zero sufficiently before striking, that is, in a position indicated by an arrow 79 which lies 60 degrees before striking. As a result, the shortage in actuating torque due to variation in relative position with the stator when the rotor stops can be reduced. In addition, the oil pulse tool which can provide the high tightening torque can be realized by increasing the rotation speed of the rotor by giving the advance angle in the position of the rotor during acceleration.

While the invention has been described based on the exemplary embodiment, the invention is not limited to the exemplary embodiment but can be modified variously without departing from the spirit and scope thereof For example, the advance angle of the driving voltage of the motor can be set to other values than the values of 0 degrees and 20 degrees. In addition, in this exemplary embodiment, while the advance angle of the driving voltage is switched abruptly at the advance angle switching points 78, 79 (refer to FIG. 4) in accordance with the rotation angle of the liner, the advance angle of the driving voltage of the motor may be increased or reduced gradually or in stage in accordance with the rotation angle of the liner. Additionally, with the prediction accuracy of the rotor position increased, the range in which the advance angle is set to 0 degrees before striking can be narrowed further, and the advance angle of the driving voltage of the motor may be controlled so as to be set to zero only in the portion ranging from 330 degrees to 60 degrees.

As the exemplary embodiment of the power tool of the invention, the invention is described as being applied to the oil pulse tool. However, the power tool is not limited to the oil pulse tool. For example, there are raised the following modified examples.

(1) The invention can also be applied to an impact tool having an anvil which is struck in a rotational direction by a hammer which is rotated by a motor. In this case, the advance angle of driving voltage of the motor is set to zero before and after the anvil is struck by the hammer. In addition, the advance angle of driving voltage is set in portions where the anvil is not struck by the hammer. The rotation speed of the hammer can be increased just before striking is performed by controlling the advance angle of driving voltage in the way described above, and therefore, the striking torque can be increased compared with the control in which no advance angle control of driving voltage is adopted throughout the control.

(2) The invention can also be applied to a striking tool such as a hammer or a hammer drill in which a drill bit is struck via a striking element by a piston which is reciprocated by a motor. In this case, the advance angle of driving voltage of the motor is set to zero before and after a position where the piston approaches the striking element side to a maximum extent. In addition, the advance angle of driving voltage is set when the piston is traveling so as to approach the striking element side. By controlling the advance angle of driving voltage in this way, the striking force when striking the drill bit by the striking element can be increased compared with the control in which no advance angle control is adopted throughout the control.

(3) The invention can also be applied to a jigsaw or a Saber saw (a reciprocating saw) in which a blade is attached to a plunger which is reciprocated by a motor. In this case, the advance angle of driving voltage of the motor is set to zero while the blade is cutting a material to be cut. In addition, the advance angle of driving voltage is set while the blade is not cutting the material to be cut. By controlling the advance angle of driving voltage in this way, the blade moves quickly while the blade is not cutting the material to be cut, and therefore, the time required for the blade to reciprocate can be shortened. In addition, the blade is driven without advance angle of driving voltage while it is cutting the material to be cut, and therefore, the cutting can be performed stably. Thus, the time required for the cutting can be shortened.

In addition to the applications described above, the invention can also be applied to power tools in which a front end tool receives a reaction force which fluctuates during the operation of the front end tool. The invention is particularly useful for a power tool in which a front end tool does not receive a reaction force which is constant but received a reaction force which fluctuates.

The invention provides illustrative, non-limiting aspects as follows:

(1) According to a first aspect, there is provided an oil pulse tool including: a brushless motor which includes stator windings; a drive circuit configured to apply a driving voltage to any of the stator windings of the brushless motor at a predetermined timing; an oil pulse mechanism portion configured to be rotary driven by the brushless motor; and an output shaft which is connected to the oil pulse mechanism portion, wherein the drive circuit changes an advance angle of the driving voltage in accordance with a rotational position of the oil pulse mechanism portion.

According to the first aspect, an increase in tightening torque is realized by increasing the maximum rotation speed of the motor by increasing the advance angle of the driving voltage. In addition, by reducing the advance angle of the driving voltage of the motor before and after striking, the oil pulse tool can be provided which eliminates the variation in tightening torque caused by the advance angle of the motor.

(2) According to a second aspect, there is provided an oil pulse tool according to the first aspect, wherein the oil pulse mechanism portion includes: a liner; and a main shaft, and wherein the advance angle of the driving voltage is changed in accordance with a relative rotational position between the liner and the main shaft.

According to the second aspect, the advance angle of the driving voltage is changed in accordance with the relative rotational position between the liner and the main shaft. Therefore, striking is performed without an advance angle, so that the motor can be re-actuated and re-accelerated in a stable fashion after striking is performed. In addition, the motor is controlled with an advance angle during the acceleration of the motor, and therefore, the rotation speed of the motor can be increased, thereby making it possible to increase the striking torque of the oil pulse tool.

(3) According to a third aspect, there is provided an oil pulse tool according to the second aspect, wherein the advance angle of the driving voltage is controlled so that the advance angle of the driving voltage becomes zero when striking is performed by the oil pulse mechanism portion.

According to the third aspect, the advance angle of the driving voltage is controlled so that the advance angle of the driving voltage becomes zero when striking is performed in the oil pulse mechanism portion. Therefore, the fluctuation of rotation of the motor can be prevented when striking is performed, that is, when the rotation of the motor tends to become unstable, whereby the motor can be driven stably.

(4) According to a fourth aspect, there is provided an oil pulse tool according to the third aspect, wherein the advance angle of the driving voltage is controlled so that the advance angle of the driving voltage is zero for a first predetermined period before striking is performed by the oil mechanism portion and for a second predetermined period after striking is performed by the oil pulse mechanism portion, and wherein the advance angle of the driving voltage is not zero on other occasions.

According to the fourth aspect, the advance angle of the driving voltage is made zero for a first predetermined period before striking is performed by the oil mechanism portion and for a second predetermined period after striking is performed by the oil pulse mechanism portion, and the advance angle of the motor is not zero on other occasions. Therefore, the acceleration of the liner can be promoted until striking is performed, thereby making it possible to generate a strong striking torque.

(5) According to a fifth aspect, there is provided an oil pulse tool according to the fourth aspect, wherein a plurality of advance angle values are prepared as the advance angle of the driving voltage, and wherein the drive circuit selects any of the advance angle values in accordance with a relative rotational position of the liner.

According to the fifth aspect, the drive circuit selects any of the plurality of advance angle values in accordance with the relative rotational position of the liner. Therefore, the control according to the invention can be realized by the simple control employing a microcomputer.

(6) According to a sixth aspect, there is provided an oil pulse tool according to the second aspect, wherein the drive circuit changes the advance angle of the driving voltage in response to an increase in load on the output shaft.

According to the sixth aspect, the drive circuit changes the advance angle of the driving voltage in response to the increase in load on the output shaft. Therefore, an appropriate striking torque can be generated in response to an increase in load.

(7) According to a seventh aspect, there is provided an oil pulse tool including: a brushless motor which includes stator windings; a drive circuit configured to apply a driving voltage to any of the stator windings of the brushless motor at a predetermined timing; an oil pulse mechanism portion configured to be rotary driven by the brushless motor; and an output shaft which is connected to the oil pulse mechanism portion, wherein the drive circuit controls the driving voltage with a fixed advance angle until a first striking is started, and wherein the drive circuit controls the driving voltage with a variable advance angle, in which the advance angle of the driving voltage is changed in accordance with a rotation angle of the oil pulse mechanism portion, after the first striking is started.

According to the seventh aspect, the drive circuit controls the driving voltage with the fixed advance angle until the first striking is performed, therefore, the work can be performed within a shortest period of time with an arbitrary advance angle (with advance angle or without advance angle) until the bolt is seated. In addition, drive circuit controls the driving voltage with the variable advance angle, in which the advance angle of the driving voltage is changed in accordance with the rotation angle of the oil pulse mechanism portion, after the first striking starts. Therefore, a highly accurate driving of the motor can be realized which takes into consideration the magnitude of striking torque and stability at the time of striking.

(8) According to an eighth aspect, there is provided an oil pulse tool according to the seventh aspect, wherein the drive circuit controls the driving voltage with an advance angle after the first striking is started, and wherein the advance angle of the driving voltage is reduced or is zero for a first predetermined period before striking is performed by the oil mechanism portion and for a second predetermined period after striking is performed by the oil pulse mechanism portion.

According to the eighth aspect, the drive circuit controls the driving voltage with an advance angle after the first striking is started, and the advance angle of the driving voltage is reduced or is zero for a first predetermined period before striking is performed by the oil mechanism portion and for a second predetermined period after striking is performed by the oil pulse mechanism portion. Therefore, the fluctuation of rotation of the motor can be prevented effectively at the time of striking.

(9) According to a ninth aspect, there is provided an oil pulse tool according to the eighth aspect, wherein, when a position of the liner where striking is performed is defined as 0 degrees, the position of the liner where the drive circuit controls the driving voltage with an advance angle which is not zero is between 30 degrees and 330 degrees.

According to the ninth aspect, the position of the liner where the control with the advance angle is performed is situated between 30 degrees and 330 degrees. Therefore, the efficiency of the motor can be increased largely while ensuring the stability thereof at the time of striking.

(10) According to a tenth aspect, there is provided a power tool including: a brushless motor; a rotary striking mechanism portion configured to be driven by the brushless motor; and an output shaft connected to the rotary striking mechanism portion, wherein an advance angle of a driving voltage applied to the brushless motor is changed in accordance with a rotational position of the rotary striking mechanism portion.

According to the tenth aspect, in the power tool having the rotary striking mechanism portion which is driven by the brushless motor, the advance angle of the driving voltage applied to the brushless motor is changed in accordance with the rotational position of the rotary striking mechanism portion. Therefore, an increase in striking torque is realized by the increase in the maximum rotation speed of the motor by the advance angle thereof, and the advance angle of the motor is reduced before and after striking is performed, thereby making it possible to provide the power tool which eliminates the variation in striking torque due to the advance angle of the driving voltage.

(11) According to an eleventh aspect, there is provided a power tool including: a brushless motor; a striking mechanism portion configured to be driven by the brushless motor; and an output shaft connected to the striking mechanism portion, wherein an advance angle of a driving voltage applied to the brushless motor is changed in accordance with a position of the striking mechanism portion.

According to the eleventh aspect, in the power tool having the striking mechanism driven by the brushless motor, the advance angle of the driving voltage applied to the brushless motor is changed in accordance with the position of the striking mechanism portion. Therefore, an increase in striking torque is realized by the increase in the maximum rotation speed of the motor by the advance angle thereof, and the advance angle of the motor is reduced before and after striking is performed, thereby making it possible to provide the power tool which eliminates the variation in striking torque due to the advance angle of the driving voltage.

(12) According to a twelfth aspect, there is provided a power tool including: a brushless motor; and an output shaft configured to be driven by the brushless motor, wherein a load on the output shaft fluctuates periodically, wherein, when the load on the output shaft is a low load, an advance angle of a driving voltage applied to the brushless motor is a first advance angle, and wherein, when the load on the output shaft is a high load, the advance angle of the driving voltage applied to the brushless motor is a second advance angle which is smaller than the first advance angle.

According to the twelfth aspect, in the power tool, the advance angle of the driving voltage applied to the brushless motor is the first advance angle when the load exerted on the output shaft is the low load, and when the load exerted on the output shaft is the high load, the advance angle of the driving voltage applied to the brushless motor is the second advance angle which is smaller than the first advance angle. Therefore, the optimum advance angle of the driving voltage can be attained in accordance with the load exerted on the output shaft, thereby making it possible to provide the power tool which increases the working efficiency.

What is claimed is:

1. An oil pulse tool comprising:
a brushless motor which includes stator windings;
a drive circuit configured to apply a driving voltage to any of the stator windings of the brushless motor at a predetermined timing;
an oil pulse mechanism portion configured to be rotary driven by the brushless motor; and
an output shaft which is connected to the oil pulse mechanism portion,
wherein the drive circuit changes an advance angle of the driving voltage in accordance with a rotational position of the oil pulse mechanism portion.

2. An oil pulse tool according to claim 1,
wherein the oil pulse mechanism portion includes:
a liner; and
a main shaft, and
wherein the advance angle of the driving voltage is changed in accordance with a relative rotational position between the liner and the main shaft.

3. An oil pulse tool according to claim 2,
wherein the advance angle of the driving voltage is controlled so that the advance angle of the driving voltage becomes zero when striking is performed by the oil pulse mechanism portion.

4. An oil pulse tool according to claim 3,
wherein the advance angle of the driving voltage is controlled so that the advance angle of the driving voltage is zero for a first predetermined period before striking is performed by the oil mechanism portion and for a second predetermined period after striking is performed by the oil pulse mechanism portion, and
wherein the advance angle of the driving voltage is not zero on other occasions.

5. An oil pulse tool according to claim 4,
wherein a plurality of advance angle values are prepared as the advance angle of the driving voltage, and
wherein the drive circuit selects any of the advance angle values in accordance with a relative rotational position of the liner.

6. An oil pulse tool according to claim 2,
wherein the drive circuit changes the advance angle of the driving voltage in response to an increase in load on the output shaft.

7. An oil pulse tool comprising:
a brushless motor which includes stator windings;
a drive circuit configured to apply a driving voltage to any of the stator windings of the brushless motor at a predetermined timing;
an oil pulse mechanism portion configured to be rotary driven by the brushless motor; and
an output shaft which is connected to the oil pulse mechanism portion,
wherein the drive circuit controls the driving voltage with a fixed advance angle until a first striking is started, and
wherein the drive circuit controls the driving voltage with a variable advance angle, in which the advance angle of the driving voltage is changed in accordance with a rotation angle of the oil pulse mechanism portion, after the first striking is started.

8. An oil pulse tool according to claim 7,
wherein the drive circuit controls the driving voltage with an advance angle after the first striking is started, and
wherein the advance angle of the driving voltage is reduced or is zero for a first predetermined period before striking is performed by the oil mechanism portion and for a second predetermined period after striking is performed by the oil pulse mechanism portion.

9. An oil pulse tool according to claim 8,
wherein, when a position of the liner where striking is performed is defined as 0 degrees, the position of the liner where the drive circuit controls the driving voltage with an advance angle which is not zero is between 30 degrees and 330 degrees.

10. A power tool comprising:
a brushless motor;
a rotary striking mechanism portion configured to be driven by the brushless motor; and
an output shaft connected to the rotary striking mechanism portion,
wherein an advance angle of a driving voltage applied to the brushless motor is changed in accordance with a rotational position of the rotary striking mechanism portion.

11. A power tool comprising:
a brushless motor;
a striking mechanism portion configured to be driven by the brushless motor; and
an output shaft connected to the striking mechanism portion,
wherein an advance angle of a driving voltage applied to the brushless motor is changed in accordance with a position of the striking mechanism portion.

12. A power tool comprising:
a brushless motor; and
an output shaft configured to be driven by the brushless motor,
wherein a load on the output shaft fluctuates periodically,
wherein, when the load on the output shaft is a low load, an advance angle of a driving voltage applied to the brushless motor is a first advance angle, and
wherein, when the load on the output shaft is a high load, the advance angle of the driving voltage applied to the brushless motor is a second advance angle which is smaller than the first advance angle.
